(19) United States
(12) Patent Application Publication
(10) Pub. No.: US 2003/0056104 A1
(43) Pub. Date: Mar. 20, 2003

(54) Digitally watermarking checks and other value documents

(76) Inventors: J. Scott Carr, Tualatin, OR (US); Geoffrey B. Rhoads, West Linn, OR (US); William C. Hein III, Glenmoore, PA (US); Marc D. Miller, Corte Madera, CA (US); Jonathan L. Hawes, West Linn, OR (US); Andrea Nicole Elovitz, Lake Oswego, OR (US); Steven W. Stewart, Tualatin, OR (US)

Correspondence Address: DIGIMARC CORPORATION, 19801 SW 72ND AVENUE, SUITE 100, TUALATIN, OR, 97062, US

(21) Appl. No.: 10/233,069

(22) Filed: Aug. 30, 2002

Related U.S. Application Data
(63) Continuation-in-part of application No. 09/939,298, filed on Aug. 24, 2001.
Application No. 09/939,298 is a continuation-in-part of application No. 09/127,502, filed on Jul. 31, 1998, now Pat. No. 6,345,104.
Application No. 09/127,502 is a continuation-in-part of application No. 09/074,034, filed on May 6, 1998, now Pat. No. 6,449,377.
Application No. 09/127,502 is a continuation-in-part of application No. 08/967,693, filed on Nov. 12, 1997, now Pat. No. 6,122,392.
Application No. 08/967,693 is a continuation of application No. 08/614,521, filed on Mar. 15, 1996, now Pat. No. 5,745,604.
Application No. 08/614,521 is a continuation of application No. 08/215,289, filed on Mar. 17, 1994, now abandoned.
(63) Continuation-in-part of application No. 09/571,422, filed on May 15, 2000.
(63) Continuation-in-part of application No. 10/172,769, filed on Jun. 14, 2002.
Application No. 10/172,769 is a continuation-in-part of application No. 10/154,621, filed on May 22, 2002.
Application No. 10/154,621 is a continuation-in-part of application No. 09/694,465, filed on Oct. 23, 2000.
(63) Continuation-in-part of application No. 10/172,506, filed on Jun. 14, 2002.
Application No. 10/172,506 is a continuation-in-part of application No. 10/094,593, filed on Mar. 6, 2002.
(60) Provisional application No. 60/158,015, filed on Oct. 6, 1999.
(60) Provisional application No. 60/163,676, filed on Nov. 5, 1999.
(60) Provisional application No. 60/356,881, filed on Feb. 12, 2002.
(60) Provisional application No. 60/316,851, filed on Aug. 31, 2001.
(60) Provisional application No. 60/327,687, filed on Oct. 5, 2001.
(60) Provisional application No. 60/352,652, filed on Jan. 28, 2002.

(51) Int. Cl. H04L 9/00

(52) U.S. Cl. 713/176

(57) ABSTRACT

The present invention provides various techniques for encoding hidden information in checks and other security documents. The hidden information provides an authentication tool. In one implementation, we provide a method for encoding a security document with information. The security document includes a substrate having printing thereon. The information is hidden in the printing and corresponds to text or numbers conveyed by at least a portion of the printing. The method includes dividing the information into a plurality of payload sets, wherein each payload set includes a sub-set of the information, and encoding the payload sets across the substrate. The plurality of payload sets is concatenated in order to retrieve the information.

### RELATED APPLICATION DATA

The present application is a continuation-in-part of U.S. patent application Ser. No. 09/939,298, filed Aug. 24, 2001, which is a continuation-in-part of Ser. No. 09/127,502, filed Jul. 31, 1998 (now U.S. Pat. No. 6,345,104). The Ser. No. 09/127,502 application is a continuation-in-part of Ser. No. 09/074,034, filed May 6, 1998. The Ser. No. 09/127,502 application is also a continuation-in-part of Ser. No. 08/967,693, filed Nov. 12, 1997 (now U.S. Pat. No. 6,122,392), which is a continuation of Ser. No. 08/614,521, filed Mar. 15, 1996 (now U.S. Pat. No. 5,745,604). The Ser. No. 08/614,521 application is a continuation of Ser. No. 08/215,289, filed Mar. 17, 1994 (now abandoned). The present application is also a continuation-in-part of Ser. No. 09/571,422, filed May 15, 2000, which claims the benefit of U.S. Provisional Application No. 60/158,015, filed Oct. 6, 1999. The present application is also a continuation-in-part of Ser. No. 10/172,769, filed Jun. 14, 2002, which is a continuation-in-part of Ser. No. 10/154,621, filed May 22, 2002. The Ser. No. 10/154,621 application is a continuation-in-part of application Ser. No. 09/694,465, filed Oct. 23, 2000, which claims the benefit of U.S. Provisional Application No. 60/163,676, filed Nov. 5, 1999. The present invention is also a continuation-in-part of U.S. patent application Ser. No. 10/172,506, filed Jun. 14, 2002, which is a continuation-in-part of U.S. patent application Ser. No. 10/094,593, filed Mar. 6, 2002 and claims the benefit of U.S. Provisional Application No. 60/356,881, filed Feb. 12, 2002. The present application also claims the benefit of U.S. Provisional Patent Application Nos. 60/316,851, filed Aug. 31, 2001, 60/327,687, filed Oct. 5, 2001, and 60/352,652, filed Jan. 28, 2002. Each of the above U.S. patent documents is herein incorporated by reference.

### TECHNICAL FIELD

The present invention generally relates to steganography and data hiding. Our inventive techniques are readily applied to checks and other security documents.

### BACKGROUND AND SUMMARY

Digital watermarking is a process for modifying physical or electronic media to embed a hidden machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by subtly altering the host media signal. The reading component analyzes a suspect signal to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in media signals are detailed in the assignee's co-pending application Ser. No. 09/503,881 and U.S. Pat. 6,122,403, which are hereby incorporated by reference.

One aspect of the present invention applies digital watermarking technology to checks and other security documents. U.S. patent application Ser. Nos. 09/074,034, 09/127,502, 09/629,649, 09/689,289 and 09/185,380 and U.S. Provisional Nos. 60/316,851 and 60/327,687, and U.S. Pat. Nos. 6,343,138 and 6,345,104, detail some of the assignee's prior work concerning application of digital watermarking to valuable documents.

In another aspect of the present invention, a so-called frail (or “fragile”) watermark is encoded in a check or other security document as an authentication tool. Fragile watermarks measurably degrade or are destroyed upon exposure to some forms of signal processing, such as scanning and then printing or copying. Fragile watermarking is detailed in various of the present assignee's prior patents and applications, including U.S. Pat. No. 6,122,403, and applications Ser. Nos. 09/498,223, 09/503,881, 09/562,516, 09/625,577, 09/625,577, 09/630,243, 09/645,779, 09/689,226, 09/689,293, 09/840,016, 60/232,163, 60/263,987, and PCT application PCT/US02/20832. Each of these patent documents is herein incorporated by reference.

Further features and advantages of the present invention will become even more apparent with reference to the following detailed description and accompanying drawings.

### BRIEF DESCRIPTION OF THE DRAWINGS

FIG. 1 is a diagram illustrating a check.

FIG. 2 is a diagram illustrating one type of background pattern for the FIG. 1 check.

FIG. 3 is a block diagram illustrating a check divided into blocks.

FIG. 4 is a flow diagram illustrating a typical check clearing process.

FIG. 5 is a flow diagram illustrating digital watermarking of electronic check images.

FIG. 6 is a block diagram of an image management system.

### DETAILED DESCRIPTION

Introduction

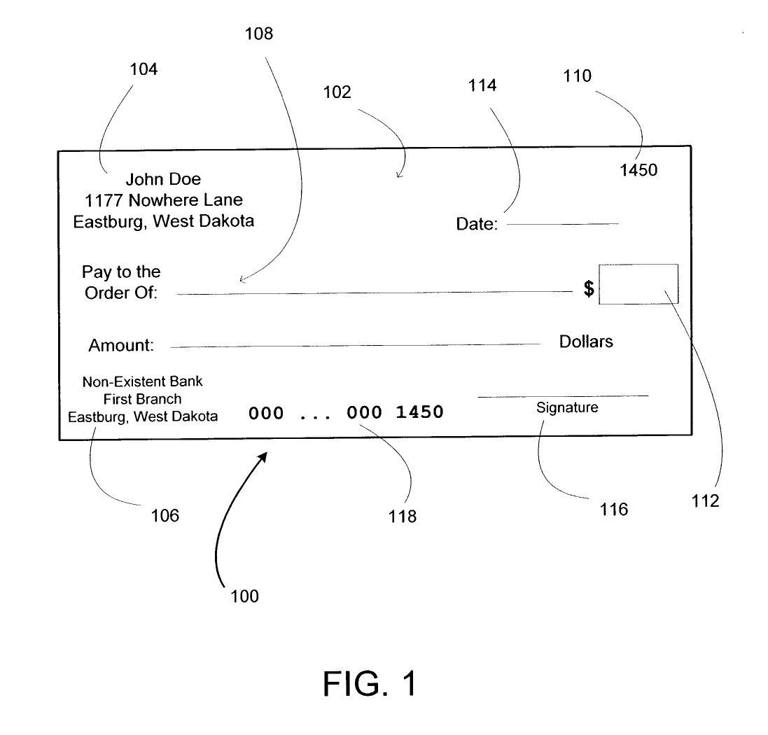

One objective of the present invention is to authenticate a check, e.g., without requiring linkage to an external system. A check is basically an order to pay and is sometimes referred to as a “draft.” There are typically three parties involved with a check. A first party (the “drawer”) orders a second party (the “drawee,” most often a bank) to pay money to a third party (the payee or bearer). An exemplary check 100 is shown in FIG. 1. Check 100 typically includes a substrate 102 made from materials such as paper or paper synthetics. Substrate 102 includes information printed thereon. The information may include drawer information 104, drawee information 106 (e.g., the bank), and payee information 108 (e.g., who the check is to). Check 100 will often include a check number 110, amount or amount area 112, date 114, signature 116 and account/bank number information 118 printed, e.g., in MICR fonts. Information 118 may also include the check number (e.g., in the illustrated example “1450”), and is often optically detectable via optical character recognition (OCR) techniques. We note that while check 100 is illustrated as being “blank,” our techniques apply to executed checks as well. Of course, the present invention envisions checks including more or less information than is illustrated in FIG. 1.

Checks are often “written” by an automated process, where the amount and payee are entered into a computerized interface and then printed by a printer. The check can include a preprinted surface, include information except for, e.g., payee and amount. Other times a check is manually written.

Authenticating Checks

One goal of the present invention is to determine if the amount 112 or payee 108 of check 100 has been altered. An alteration attack could be by someone equipped with a scanner and ink jet printer who has the ability to scan a check and reproduce it. The most common attack may be to scan the check, change the amount, and print it. Perhaps printing it many times, with different amounts. Further, printing it with different payees.

Its reasonable to assume that checks can be produced from a combination of master stock, background patterns that are printed on-demand, and the typical black-print used to “make out” the check.

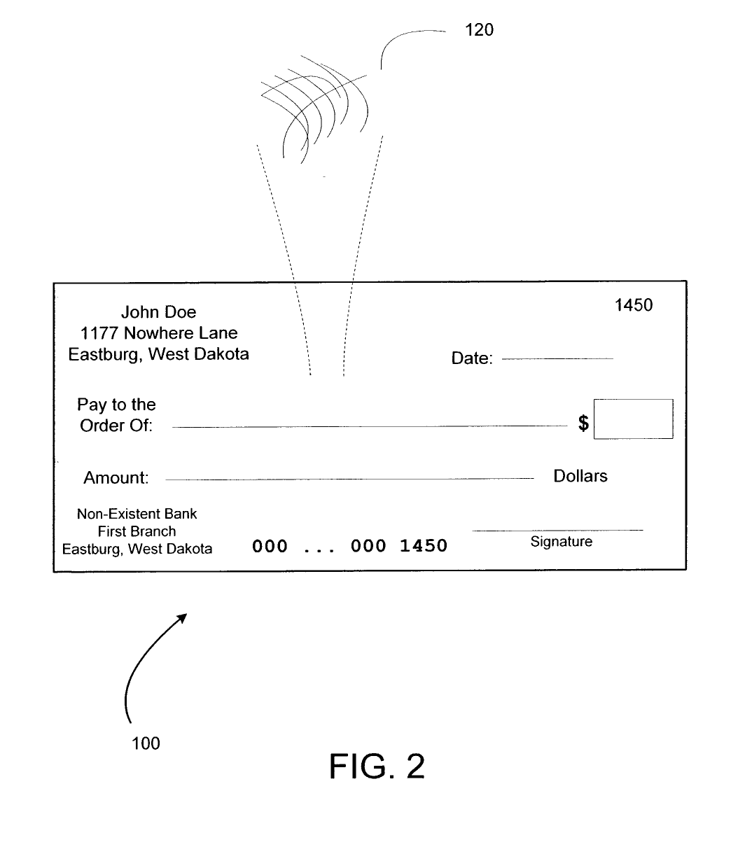

In one implementation, we embed indicia (e.g., a digital watermark or machine-readable code) in a background pattern 120 (FIG. 2) or tint to help prevent such copying. We note that while background 120 is illustrated as including line art, the present invention is not so limited. Various other background-embedding techniques are disclosed in, e.g., assignee's U.S. Pat. No. 6,345,104, and U.S. patent application Ser. Nos. 09/465,418 and 09/571,422. Still other background patterns include graphics and images. We can also embedded a digital watermark in background images, patterns and graphics, etc. When used as a background pattern or part of a graphic design, it is not critical that the watermark representation be essentially unnoticeable to the viewer. If desired, a fairly visible pattern can be used without impairing the use of the underlying document. We note, however, that the marking of the document (e.g., the information carrying aspect of the watermark) preferably remains generally imperceptible to the viewer. (In contrast, a document including a barcode is marked in a generally perceptible manner, e.g., a human observer knows that the barcode is a marking conveying information, even if the human can not interrupt the marking.). In other cases we use a pure or raw watermark signal as at least a portion of a background pattern 120 or tint.

(Instead of a background pattern we can embed a digital watermark in a foreground image or graphic.).

In another implementation we embed a digital watermark through printer font alterations, e.g., as discussed in assignee's U.S. patent application Ser. No. 10/187,252, filed Jun. 28, 2002. This application is herein incorporated by reference.

In other implementations, a pattern that carries the watermark may itself be a latent image that shows up when a copy is made, sort of like Micro-SAM from security printer Enschede. (See, e.g., U.S. Pat. Nos. 5,374,976, 5,582,103, 5,437,897, 4,420,174 re latent image formation. Each of these patents is herein incorporated by reference.) In other words, the background pattern would itself be a security feature as well as a data carrier.

Digital watermarks can serve as a means to detect check fraud. A fragile watermark is provided to help prevent “copies” of a valid check from being proliferated. In one implementation, a centralized database contains replicas of authorized signatures that are used to detect unauthorized use of the checks. Digital watermark identifiers are used as an index (or key) into that database to look up the authorized signatures.

Fragile watermarking techniques are also helpful in preventing others from reproducing checks (e.g., making copies of valid checks for invalid/unauthorized use). A fragile watermark will not copy properly, providing a clue or tale that the check is a counterfeit. Or to help thwart “look-alike” checks, a fragile watermark may decay when copied such that the absence of or an improper protocol/payload structure is found.

A fragile watermark is preferably embedded in a check image or background pattern 120. A copy is detected when an expected fragile watermark is lost or degraded. A fragile watermark can be referred to as an “authentication mark.”

In another implementation, e.g., for use in a background printed on the check, we encode a watermark so that a watermark message is divided into blocks (or subsets), with each block carrying in it a multi-bit payload, but where the blocks have differing payload subsets. So, like some video watermarks, the total watermark message adds up over (or is otherwise constructed from) the sum of the message blocks. To effectively recover the message, each message block is recovered from the check and combined to convey the message. There can be redundancy within each watermark block, and there might be a couple copies of the total message across the face of the check. In some implementations, the blocks are arranged spatially over the face of the check. In other implementations, the blocks are arranged over a frequency domain representation of the check.

This concatenated payload preferably corresponds to information convey by the check, e.g., the amount of the check and the payee. Checksums and error correction/detection may be employed over the total message to ensure its integrity. The total watermark may be fragile (a.k.a. frail) so that it doesn't survive copying, or robust to survive the typical wear and tear of a check. Multiple watermarks may be used, with some robust and some fragile. The same data may be carried in both, or different data in both, or a combination.

Concerning authenticating the amount and payee, there is other valuable information printed on the check that could be encoded in the concatenated watermark, such as the bank routing number, the company name of the issuer, etc.

Desirably, the watermarking would employ a keyed prototcol, so that only those properly authorized by the issuer can inspect the check (i.e., a private watermark vs. a public watermark).

There are of course several possible inspection points of an authentication watermark. One is at the Federal Reserve Bank, which may employ at least spot inspection of, e.g., random checks, and may perform high-speed inspection of most or all checks. A check is digitally imaged, and the watermark detected from such image. This digital image is stored and transmitted throughout the clearing process.

Another inspection point is at the various banks that might process the check. A special purpose reader could be provided to examine any Federal Reserve check. This might be only at the large commercial banks that deal with such checks.

Conceptualizing the system more generally, such a validation system could move down to the merchant, e.g., being integrated in cash handling equipment and point of sale machines.

A watermark reader device (e.g., a workstation equipped with scanning and processing devices) could also process other features on the check, such as the MICR 118 print at the bottom of the check. In this way, the feature can be integrated into the point of sale check verification devices, and perhaps find its way into many computer printed checks, not just Federal Reserve checks.

While one purpose of this system is to authenticate without linking to an external system, it would also be valuable to have a unique code (or identifier) in each check. The code can be carried by a digital watermark component embedded in an image or background that is robust, or semi-robust. The Federal Reserve doubtless has a record of each check it cuts. If a digital image of the check in the system is tied back to that information, in a means that is other than the MICR printed check number (i.e., the watermark identifier) that would provide added security and functionality.

Further an authentication mark can be layered with other digital watermarks. So, a digital watermark encoded in a master check stock can be used to detect checks in personal computers and other imaging equipment with the purpose of deterring counterfeiting.

Covert markings could be encoded in the master stock, or in the background printing, to covertly link to the date of the master stock production, the date the check was printed, an identity for the check printer themselves, expected amount or payee, an equipment ID of the specific printer used to print the check, or other information used to track the check.

There are other documents other than checks that have similar characteristics and needs. For example, a Diamond certificate contains the weight, color and clarity of the diamond, and is used to establish the diamond's value. If altered, this information can be used to artificially inflate the worth of a stone. By using a concatenated authentication watermark, as described above, we can similarly certify the data on the printed page. In this case, the readers might be located only at authorized diamond merchants.

Preventing Washing

Millions of dollars are stolen through so-called “washing.” Forgers and thieves use a washing process (e.g., chemical processing) to remove or erase ink from an executed check. (Typical chemicals used for washing include acetone, benzene, carbon tetrachloride and bleach, etc. Washing can also involve clear correction fluids as well as high performance erasers.). Forgers are free to alter the payee and amount on the check once the ink is removed (or “washed away”).

An improvement is to embed a digital watermark in a check using washable ink. (The term “washable ink” implies that the ink is susceptible to washing. We note that many conventional inks can be washed if the above-mentioned chemicals and/or fluids are applied.). Preferably, the digital watermark is embedded in a check area (e.g., payee and/or amount area), which is likely to be washed. Washing will remove or erase a watermark when the watermark embedding is limited to a high-probability washing area (e.g., amount and payee).

As an alternative, a watermark component is strategically positioned around high-probability washing areas. Then, before a check is accepted or cashed, the check is scanned for the expected washable ink digital watermark or watermark component. The check is considered invalid or suspect if the washable ink watermark is missing or degraded.

In a related embodiment, a first watermark is embedded in the check. The first watermark includes a message indicating the expected presence of a second digital watermark. The second digital watermark is embedded (e.g., in a background pattern or tint) in a high-probability washing area (e.g., amount or payee). If the first watermark is detected—and announces that a second digital watermark is expected—but the second digital watermark is not found (or is found but is degraded), the check is considered invalid or suspect.

Of course our inventive check-washing identifying technique is not limited to checks. Rather, our inventive washable watermark can be applied to other document in which a counterfeit may apply an analogous washing procedure such as documents with hand signatures, appraisals, certificates, degrees, legal documentation, birth certificates, etc., etc.

Self-Authenticating Checks

Digital watermarks also provide a self-authenticating functionality. Consider a patron who presents a check to a bank. The bank scans the check to ensure that the check has a digital watermark embedded therein. If a watermark is not found, the check is considered a counterfeit. In some implementations, the watermark includes information such as the check maker's account number, the issuing bank's routing number or ID, and even the check amount. A bank (or check cashing location) can decode the watermark, obtain the watermark identifier, and compare the watermark identifier against the printed bank and account information or against additional confidential information (or personal identification documents) or payment amount. The watermark identifier can also include the check number, which can be similarly verified. By recording the check number and/or amount, a database record can be maintained to help prevent a counterfeiter from making multiple copies of a single check or altering the check amount. The database is updated is reflect the first instance of the check.

Digital watermarking can be combined with database authentication. Using a watermark identifier, a bank can interrogate a database to check (or verify) the watermark's authenticity, the bank/individual/company/account number/check number, etc. (Randomizing the selection process for assigning a watermark identifier can further enhance security.). The database is preferably the only mechanism used to associate the watermark identifier and the account/bank/check information.

In one implementation, a signature line is scanned and compared to any authorized signatures in the database. Of course, the appropriate database record is accessed via the watermark identifier as discussed above. Even stolen checks can be detected using such measures. (E.g., a flag or data entry can be set in the database to indicate the theft. The watermark helps to retrieve or access this information.).

Methods and devices for watermark detection range broadly. Watermark detection devices may include input devices such as conventional web cameras or sophisticated optical sensors and specialized scanning devices. The techniques disclosed in parent U.S. patent application Ser. No. 09/571,422, which is herein incorporated by reference, is particularly helpful to facilitate the linking functionality of this aspect of the invention.

Block-Embedding

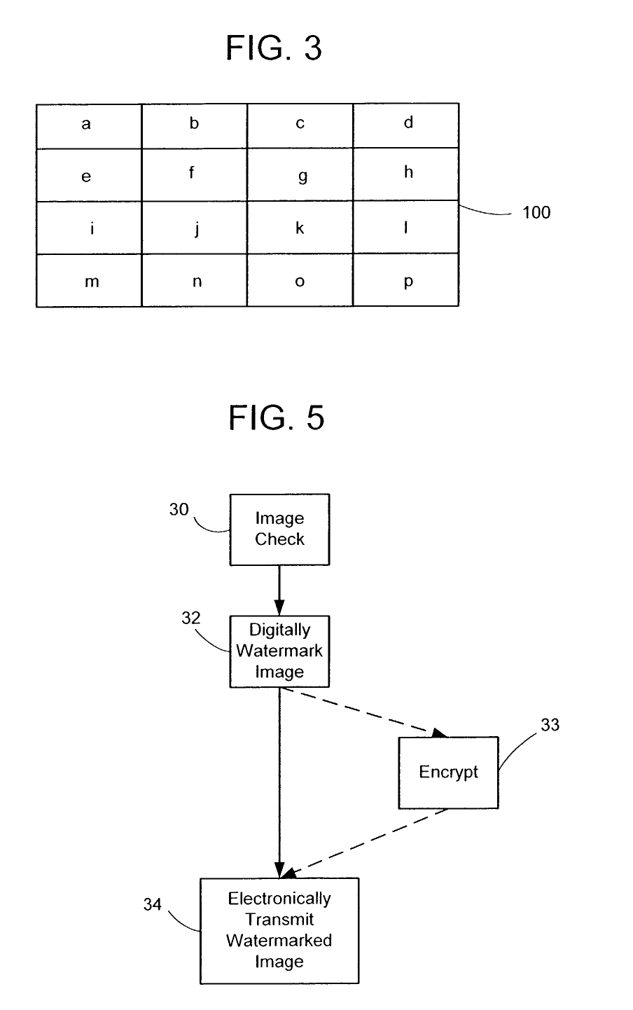

Another aspect of the present invention is now disclosed with reference to FIG. 3. A check 100 is segmented into blocks a-p. It should be appreciated that while FIG. 3 is illustrated as including a 4×4 block segmentation scheme the present invention is not so limited. Indeed, the check can be divided into any number of segments such as a 32×32, 128×128 or 3×4, etc.

In a first implementation, a digital watermark is redundantly embedded in blocks a-p. That is to say, the same watermark signal component (or message payload) is redundantly embedded throughout check 100. This implementation is particularly helpful is cases where the check 100 becomes partitioned (e.g., cut or torn).

In a second implementation, a digital watermark is placed in a predetermined (or randomly selected) block area. For instance, a digital watermark component is embedded in block o. In one case, this digital watermark carries information that is related to information printed in area o—as might be expected in one implementation of the check-washing example provided above. Or the digital watermark carries information that corresponds to information printed elsewhere on the check. For instance, the watermark in block o may correspond to information printed an alternative area, e.g., in which a bank address or routing number is printed. Or a message subset can be positioned to correspond with block b, while other message subsets can be positioned to correspond with blocks e-j, etc.

Comparing Watermark Information with Printed Information

An embedded digital watermark can include information which matches printed information, or may include information that matches printed information printed in a specific block, oh say block b. The watermark is decoded to retrieve the information. The message information is compared against the printed information for verification. Or the digital watermark in block area “a” may include the check drawer's address information, which can be used to verify the printed information once decoded. As an alternative, a watermark includes the amount and/or payee information. This watermark information can be embedded at the time of printing to match or coincide with the printed information. This watermark information is used to verify the check's authenticity. (To illustrate, consider a check that has been altered to read $1000.00, when the original check was only for $100.00. The digital watermark carries the original amount ($100.00), which fails to correspond to the alteration ($1000.00). A counterfeit is detected by such a comparison.). Another (or alternative) watermark payload may include a batch or run number (e.g., check was printed in batch 17894, run 10 or 12, at printing location alpha, job 7 on Jan. 27, 2002, etc. Machine-readable information on the check (e.g., MICR font printed information) can be machine-read and compared against information decoded from a digital watermark. Or, once the watermark payload is decoded, a human-visual inspection may inspect printed information to determine authenticity. A copy is determined when the information does not coincide. Of course this process can be automated.

In yet another implementation, check 100 includes a plurality of watermarks or watermark components embedded in different areas. A first watermark is embedded, e.g., in block area f, while a second watermark is embedded, e.g., in block area m, and so on. The first and second digital watermark can include different information, or one watermark can include a key to decode the other watermark. In some cases one of the first or second digital watermarks is a fragile watermark as discussed above.

Watermarks in a Check Clearing Process

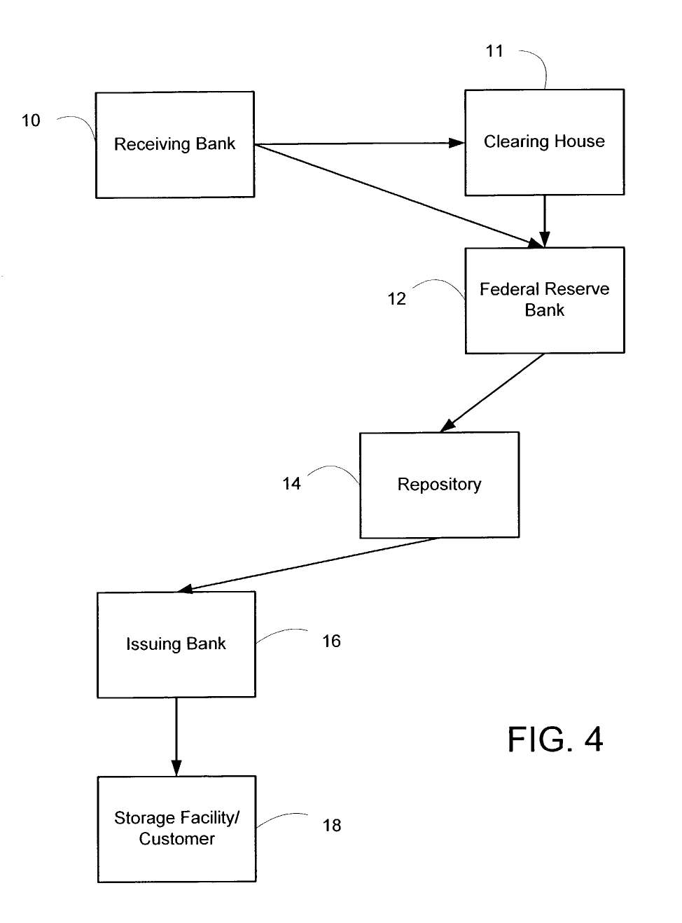

Processing checks is a costly and time-consuming endeavor. Consider a typical clearing process as shown in FIG. 4. An individual cashes a check at receiving bank 10 (or a check cashing station or store forwards the check to receiving bank 10). Receiving bank 10 forwards the check to the Federal Reserve Bank 12 for processing (sometimes through a clearing house 11). The check is routed back to the check's issuing bank 16 (e.g., perhaps through a handler house or repository 14). The issuing bank 16 may convert the check to microfilm, a digital copy and/or forward the check (or film/digital images) to a storage facility 18 or to the check drawer (customer). This process involves time and millions of dollars to physically transfer paper checks via the FIG. 4 clearing process.

One improvement involves “truncating” this check clearing process. Truncating in this document generally refers to a process of communicating a check's information in an abbreviated or alternative form. One alternative form is a digital image of the check. Another is a data file or data bits including the check's pertinent information. Of course there are other truncating alternative that will benefit from our inventive techniques.

With reference to FIG. 5, a receiving bank images a check (step 30). This process typically involves creating a digital image of the check. The imaging can be facilitated at a variety of locations. In a first implementation, receiving bank 10 or clearing house 11 images the check. In another implementation, a point of sale (POS) location (e.g., grocery store, gas station, shopping mall, etc.) or automatic teller machine (ATM) images a check. The imaging can be facilitated with known imaging apparatus, such as a reader/sorter known to banks or with other conventional imaging apparatus (e.g., scanners, digital cameras, CCD arrays, etc., etc.).

The captured image is digitally watermarked (step 32). The digital watermark can include a variety of different information. In one implementation, the watermark includes message bits to convey information related to printed information (e.g., check amount, data, issuing bank, account or check number, etc.) on the check. OCR software can be used to convert printed information into digital information, which can be carried by the watermark. Or the information can be obtained from a bank teller's or ATM's handling of the check. In another implementation, the digital watermark includes information to identify the source of transfer (e.g., the drawee or receiving bank, ATM, etc). The watermark information can include a binary, numeric identifier or an alphanumeric message, etc. In still a further implementation, the above information is stored in a database and the digital watermark includes an index to interrogate the database to retrieve such information.).

The digitally watermarked image is optionally encrypted (e.g., step 33). In one implementation, the encryption and digital watermarking are interrelated. For example, the image is watermarked, but the watermark includes an encrypted payload or message. Regardless of whether encryption is used, the digitally watermarked image is electronically transferred in step 34. For example, the watermark image can be electronically transferred from receiving bank 10 to the Federal Reserve Bank 12. Or from the Federal Reserve Bank 12 directly to the issuing bank 16, etc.

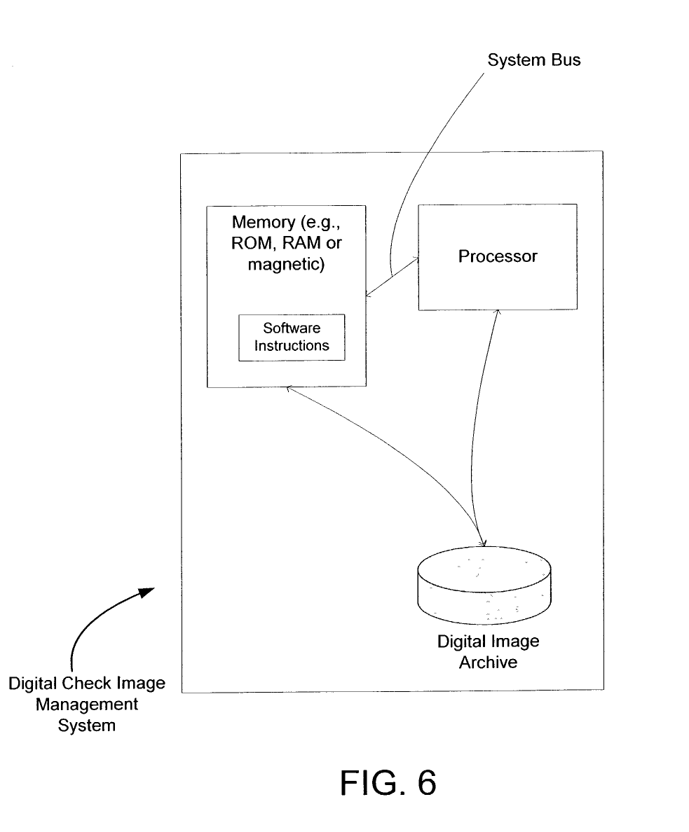

A system for carrying out the FIG. 5 process is discussed with reference to FIG. 6. Digital check images are stored in an archive, such as in an image database or storage server. Memory, including software instruction stored therein, is also provide. The software instructions preferably include at least digital watermarking instructions as well as instructions to associate a watermark identifier with related information such as check or checking account details. The association can occur in the memory or in an associated data structure. Of course a system bus can facilitate the communication between memory and an instruction processor and/or the archive. (We note that the system will optionally include a user interface, output channels and a network connection. We also note that the archive need not be physically co-located with the processor and memory. Instead of communicating with the image archive directly via the system bus, a network connection can provide a communications channel.).

To provide additional security, in one embodiment, the digital watermark preferably comprises a fragile watermark (or a fragile watermark component). The fragile watermark can be evaluated to determine if the check image is authentic.

Our inventive system and methods help to provide a secure electronic transfer system, which can alleviate the need to transfer or route physical paper checks through the FIG. 4 clearing process.

Image Replacement Documents

Another aspect of our present invention involves digitally watermarking so-called Image Replacement Documents (IRDs). Returning to FIG. 4, an issuing bank 16 or storage facility 18 may include a digital archive to house digital images of checks. When a bank or customer needs a duplicate check copy, e.g., for tax purposes or as a receipt, the storage facility prints out an IRD for the customer. Our improvement includes several inventive aspects.

A first aspect includes digitally watermarking the IRD during printing. The watermark provides an authentication tool (a.k.a., a fragile watermark). Or the watermark can include account details, check amount or other details (e.g., processing history), printing details, printer identification, a timestamp, customer details, etc. Or the watermark can carry an index to either index back into the digital check archive or to a database including the customer, printing or bank information.

A second aspect includes digitally watermarking a digital image of a check to include an identifier. The watermark identifier serves as a backbone of a digital asset management system (e.g., for the check image archive). A check image is stored in the database archive according to its index. Metadata or other files (e.g., check processing history, account information, customer and bank information, etc.) is associated with the digital check image via the identifier. If the image is found outside the digital asset management system, the digital watermark identifier is extracted and used to link into the digital image archive, e.g., to access the corresponding metadata or other files.

Printing Watermarks in Multiple-Stages In parent application Ser. No. 10/172,769 we disclose techniques by which a first watermark component is embedded in a document during a first printing stage, and then a second watermark component is embedded in the document during a second and later printing stage.

As is evident in the parent application these techniques are well suited for checks.

Consider a check that is pre-printed with background patterns and/or images and drawee, drawer and account information. The check can be digitally watermarked during that pre-printing stage, e.g., by encoding the patterns or images with hidden information. The first watermark component can carry information related to the drawee, drawer, account, etc. Or the first watermark component can be a fragile authentication watermark. In an alternative implementation the first watermark component includes an orientation component to help resolve issues of image distortion such as scaling, rotation and translation.

The check is supplied to a customer (drawer) who executes the check. Often the execution will involve a second printing process, which adds the amount or payee information. A second digital watermark component can be added during this second printing stage. The watermarking can be accomplished in a number of ways. For example, additional ink can be added to a background pattern to convey the second watermark component. The original background pattern can be considered when adding the additional ink, or the additional ink can be added without regard to the original background pattern. Or additional line art, graphics, logos can be printed, each with a watermark component embedded therein. The second watermark component can be relatively unobtrusive, particularly when the first watermark component includes an orientation component.

Linking ID documents to Checks

In parent application Ser. No. 10/172,506 we disclose techniques by which a first document is linked to a second document via digital watermarking.

These techniques can, of course, be used to authenticate checks.

Consider an employer who wishes to cut a check to an employee. The employer wishes to minimize the risk of a counterfeiter intercepting the check and making illicit copies. So the employer issues the employee a watermarked identification document. (In some cases the employee will already have a watermarked identification document, such as a watermarked driver's license or passport.) The watermarked identification document includes a unique first identifier. Prior to cutting the check, the employer decodes the watermark embedded in the employee's identification card to obtain the first identifier. The first identifier is used to provide (or formulate) a second identifier. The second identifier is embedded in the employee's check. The check and the employee's watermarked identification document are linked through the first and second watermark identifiers.

To verify permission or authority to cash or deposit the check, a bank or checking cashing location decodes the first identifier from the employee's identification document, decodes the second identifier from the check, and then determines whether the first and second identifiers are related. The employee is consider to have authority to cash the check if the first identifier and the second identifiers coincide.

The first and second watermark identifiers can coincide in a number of ways. In a first implementation, the first identifier and second identifier are the same. In a second implementation, the second identifier includes a subset of information included in the first identifier. In a third implementation, the second identifier is a cryptographic permutation of the first identifier. In a forth implementation, the first identifier comprises a key to decode or otherwise decrypt the second identifier. In a fifth implementation, the first and second identifiers are related in a predetermined manner.

The check watermark may also be fragile to help further deter counterfeiting efforts.

Concluding Remarks

Having described and illustrated the principles of the technology with reference to specific implementations, it will be recognized that the technology can be implemented in many other, different, forms.

For example, while the above techniques have focused on checks, other security documents will benefit from our techniques such as notes, drafts, mortgages, traveler's checks, commercial paper, jewelry certificates, appraisals, insurance documentation, etc.

Another alternative implementation provides encoded information hidden in the surface topology of a check. That is to say, surface features like texturing conveys plural-bit information.

The methods, processes, and systems described above may be implemented in hardware, software or a combination of hardware and software. For example, the data encoding processes may be implemented in a programmable computer or a special purpose digital circuit. Similarly, data decoding may be implemented in software, firmware, hardware, or combinations of software, firmware and hardware. The methods and processes described above may be implemented in programs executed from a system's memory (e.g., a computer readable medium, such as an electronic, optical or magnetic storage device).

To provide a comprehensive disclosure without unduly lengthening the specification, applicants incorporate by reference the patents and patent applications referenced above.

The particular combinations of elements and features in the above-detailed embodiments are exemplary only; the interchanging and substitution of these teachings with other teachings in this and the incorporated-by-reference patents/applications are also contemplated.

What is claimed is:

1. A method for encoding a security document with information, said security document comprising a substrate having printing thereon, the information being hidden in the printing and corresponding to text or numbers conveyed by at least a portion of the printing, said method comprising:
dividing the information into a plurality of payload sets, wherein each payload comprises a sub-set of the information; and
encoding the payloads across the substrate, wherein the plurality of payload sets is to be concatenated in order to retrieve the information.

2. The method of claim 1 wherein the substrate is divided into blocks and said encoding step redundantly encodes respective payloads within respective blocks so that each block only has one payload redundantly encoded therein.

3. The method of claim 1 wherein the correspondence between the information and the text or numbers comprises an authentication tool.

4. The method of claim 1 wherein the encoding of the plural-bit information comprises a digital watermark.

5. The method of claim 4 wherein the digital watermark is encoded according to a private key.

6. The method of claim 4 wherein the digital watermark comprises a fragile watermark.

7. The method of claim 1 wherein at least a portion of the printing comprises a background pattern or tint, and the information is encoded in the background pattern or tint.

8. The method of claim 7 wherein the information comprises at least one of amount, payee, drawer, drawee and account information.

9. The method of claim 1 wherein the security document comprises a check.

10. A check including a substrate and a pattern printed on the substrate, the check being characterized in that the printed pattern includes a latent image that is generally imperceptible to human observers of the check, but betrays its existence upon copying, wherein the latent image includes plural-bit information encoded therein, and wherein the plural-bit information is generally imperceptible to human observers of the check and does not betray its existence upon copying.

11. The method of claim 10 wherein the pattern comprises a background pattern, and the latent image comprises a security feature as well as the data carrier for the plural-bit information.

12. A method of encoding information on a check, said method comprising:
providing a first digital watermark component including orientation information;
embedding the first digital watermark component in first print data, and applying the embedded first print data to the check using a first printing process;
providing a second digital watermark component including a payload; and embedding the second digital watermark component in second print data, and applying the embedded second print data to the document using a second printing process, wherein the first printing process and the second printing process are separate printing processes.

13. A method of authenticating a check including optically-detectable indicia thereon, said indicia being machine-readable, said check further including a marking to convey plural-bit information wherein the marking is not apparent to human observers of the check, yet can be detected from image data generated by optically scanning the check, said method comprising the steps of:
optically scanning the check to detect the indicia;
optically scanning the check to detect the marking and decoding the detected marking to obtain the plural-bit data; and
comparing the plural-bit data with the indicia to determine whether the check is authentic.

14. The method of claim 13 wherein indicia comprises numbers or text.

15. The method of claim 13 wherein the marking comprises a background pattern or tint

16. The method of claim 13 wherein the marking comprises an image or graphic.

17. A method of linking an identification document to a security document, the identification document comprising a first digital watermark including a first identifier, said method comprising:
decoding the first digital watermark to obtain the first identifier;
providing a second identifier, wherein the first identifier and the second identifier correspond; and
embedding in the security document a second digital watermark including the second identifier.

18. The method of claim 17, wherein the second identifier comprises the first identifier.

19. The method of claim 18, wherein the second identifier comprises a cryptographic permutation of the first identifier.

20. The method of claim 17, wherein the second identifier is randomly or pseudo-randomly generated, but is associated with the first identifier through a data record.

21. The method of claim 17 wherein the security document comprises a check.

22. The method of claim 21 wherein the identification document comprises at least one of a driver's license, passport, visa, employee badge, photo identification, social security card, and birth certificate.

23. An authentication method for the security document produced according to the method of claim 22, the authentication method comprising the steps of:
decoding the first digital watermark from the identification document to obtain the first identifier;
decoding the second digital watermark from the security document to obtain the second identifier; and
comparing the first identifier and the second identifier to determine whether the security document is authentic.

24. The method of claim 23, wherein said comparing step comprises determining whether the first identifier and second identifier match.

25. The method of claim 23, wherein said comparing step comprises determining whether the second identifier comprises a cryptographic permutation of the first identifier.

26. A method of truncating a check clearing process comprising the steps of:
capturing a digital image of a cashed or deposited check;
digitally watermarking the digital check image to include an identifier;
electronically transmitting the digitally watermarked digital check image to a first receiving destination; and
authenticating at the receiving destination the digital check image at least in part by the identifier.

27. The method of claim 26 wherein the identifier comprises a fragile watermark component, and said authenticating step comprises analyzing the fragile watermark component to determine whether the digital check image has been altered.

28. The method of claim 26 further comprising encrypting the identifier prior to said digitally watermarking step.

29. In a system to manage digital check images comprising:
a digital image archive including at least one digital image of a check;
a processor;
a system bus;
a memory in communication with the processor via the system bus, said memory including computer executable instructions stored therein, said instructions including instructions to:
digitally watermark the digital image of the check to include multi-bit information, wherein the digital watermark is robust to survive printing of the digital image of the check to a paper form; and
associate checking account or check data with the multi-bit information.

30. The system according to claim 29 wherein the data comprises at least one of check amount, payee, date check cleared and checking account number.

31. A method of interaction with the system of claim 29, comprising the steps of:
decoding the multi-bit information from a paper version of the digitally watermarked check image; and
accessing at least one of the digital image archive or the check data at least in part by the multi-bit information.

32. A method to identify whether washing has been applied to a security document, the washing serving to alter or remove at least a first set of information provided on the security document, wherein the check comprises a substrate having a first area, and wherein the first set of information is provided in the first area of the substrate with an ink or dye, said first area further comprising information hidden therein, said method being characterized by optically sensing the first area to detect the hidden information, and if the hidden information is not found, identifying the security document as being washed.

33. The method of claim 32, wherein if the hidden information is found, said method further comprises comparing the hidden information with the first set of information for correspondence and identifying the security document as being washed when the hidden information and the first set of information do not correspond.

34. The method of claim 32 wherein the security document comprises a check.

35. The method of claim 32 wherein washing comprises applying a chemical to the security document to remove or erase at least the first set of information.
